(19) United States
(12) Patent Application Publication
(10) Pub. No.: US 2013/0248324 A1
(43) Pub. Date: Sep. 26, 2013

(54) TRANSPORT DEVICE AND TRANSPORT METHOD WHICH ROTATE A PLURALITY OF TRANSPORTED HOLDING DEVICES

(71) Applicant: SIEMENS AKTIENGESELLSCHAT, Munchen (DE)

(72) Inventor: PETER BERDELLE-HILGE, KONSTANZ (DE)

(73) Assignee: Siemens Aktiengesellschat, Muenchen (DE)

(21) Appl. No.: 13/850,759

(22) Filed: Mar. 26, 2013

(30) Foreign Application Priority Data
Mar. 26, 2012 (DE) 10 2012 204 824.3

(51) Int. Cl. B65G 19/02

(52) U.S. Cl. CPC B65G 19/02
USPC 198/375

(57) ABSTRACT

A transport device transports articles by using a plurality of holding devices, in particular flat mail items in storage pockets. The transport device transports the holding devices along a guide device. The guide device contains a first rotary section and a following second rotary section. A holding device is rotated around a first axis of rotation during transportation along the first rotary section, and is rotated around a second axis of rotation during transportation along the second rotary section. Both axes of rotation stand perpendicularly with respect to the current transportation direction in which a holding device is transported, and are not parallel to each other, but stand e.g. perpendicularly on each other. An article can be placed into a space which is enclosed by at least two delimiting elements of the holding device. While the holding device containing the articles is transported along the two rotary sections, the article is aligned with the two delimiting elements of the holding device by the force of gravity.

### CROSS-REFERENCE TO RELATED APPLICATION

This application claims the priority, under 35 U.S.C. §119, of German application DE 10 2012 204 824.3, filed Mar. 26, 2012; the prior application is herewith incorporated by reference in its entirety.

### BACKGROUND OF THE INVENTION

### Field of the Invention

The invention relates to a transport device which transports articles by a plurality of holding devices, and to a transport method.

The task of transporting articles by holding devices arises e.g. within a sorting system which sorts a plurality of articles and in so doing distributes the articles that are to be sorted to different sorting terminal stations of the sorting system. The articles are for example flat mail items having different dimensions. The articles are sorted in that they are placed into holding devices and the holding devices containing the articles are sorted and at the same time transported.

A transport mechanism associated with a sorting machine for flat mail items is described in U.S. Pat. No. 6,802,503 B2. The transport mechanism transports the mail items with the aid of a multiplicity of holding devices (“transport boxes 2”) which are conveyed along a guide device (“guide rail 3”). Located beneath the holding devices 2 is a sequence of collecting containers (“collection boxes 5”). A mail item slides downward out of a holding device 2 into a collecting container 5. The guide device 3 is turned in upon itself (“twisted around the center line”) such that a holding device 2 is rotated about an axis of rotation parallel to the “center line” when the holding device 2 is transported along the twisted guide device 5.

A system and a method for sorting and at the same time conveying articles are described in U.S. Pat. No. 5,990,437. A plurality of “carrying trays” 14 are transported along a “track assembly” 12 (see FIG. 1). The “track assembly” 12 defines a continuous pathway or conveying route for the “trays” 14, and the “trays” 14 are conveyed past “article loading stations” 16. The “track assembly” 12 transports “trays” 14 along a “drive track” 22 and a “tray support rail” 24 (see FIG. 1B). The units 22, 24 have sections at various height levels. A “framework” 28 supports the “drive track” 22 and the “tray support rail” 24 in “first, second, and third elevational orientations” 32, 34, 36. The “first elevational orientation” 32 is shown in FIG. 1B, and a “tray” 14 is shown in a horizontal position. In the “second elevational orientation” 34 the “drive track” 22 and the “tray support rail” 24 are guided in such a way that a “tray” 14 is rotated (“tilted”) and an article slides toward the “trailing side wall” 40 of the “tray” 14 (see FIG. 1B). In the “third elevational orientation” 36 the “tray” 14 is tilted laterally (see FIG. 1C). In an alternative embodiment a “fourth elevational orientation” 35 causes the “leading edge” 15 of the “tray” 14 to be tilted downward relative to the “trailing edge” (see FIG. 1D). The “tray” 14 is then tilted laterally. In another embodiment the “tray support rail” 24 is lowered relative to the “drive track” 22 (see FIG. 4, FIG. 5A, FIG. 5B).

An alignment device for an article disposed in a container is described in published, non-prosecuted German patent application DE 102005038622 A1. The container has a lower wall and a lateral wall. The article is aligned by aligning two sides of the article with the two walls. The container is connected to a triggerable rotary circuit. The rotary circuit is able to move the container either into a horizontal position or into an inclined position. In one embodiment the container is a storage pocket 1 which holds a flat mail item in an upright position. The storage pocket 1 is suspended from an arm 4 at two points 5, 6. The rotary circuit is able to release the connection of the storage pocket to the arm 4 at point 6. As a result the storage pocket is now suspended from the arm 4 at point 5 only, and the storage pocket is tilted due to the force of gravity. In another embodiment a sliding floor 7 lies on the floor 1b of a storage pocket 1, which sliding floor 7 can be moved relative to the floor 1b and as a result of its movement actively displaces the mail item onto a sidewall 1a of the storage pocket 1.

A transport mechanism for a plurality of containers, e.g. for bottles 2, is described in published, non-prosecuted German patent application DE 102006022465 A1. A transport element 3 is conveyed along a closed-loop conveying path and in each case carries with it a bottle 2 by a container holder 6. Each container holder 6 is attached to the transport element 3 by a retainer 7. Each container holder 6 is able to be rotated around more than one axis, as a result of which different swivel movements rotate the container holder 6 relative to the transport plane 3. In one embodiment two swivel axes S1, S2 of said swivel movements stand perpendicularly on each other (see FIG. 3 and FIG. 4 of published, non-prosecuted German patent application DE 102006022465 A1). The container holder 6 can also be moved linearly up and down.

A sorting system for flat mail items is described in published, non-prosecuted German patent application DE 10 2009 053 051 A1. A buffer device 30 having a plurality of buffer storage locations 40 transports flat items 20 in the transportation direction P1 (see FIG. 1). An item 20 is dropped from a buffer storage location 40 into an intermediate storage location 70 of an intermediate store 60. The intermediate store 60 is moved in a transportation direction P2 (see FIG. 1 and FIG. 3) or is stationary (see FIG. 4). The item 20 slides out of an intermediate storage location 70 into a container 80. In one embodiment individual items 20 are fed by a loading device 90 directly into an intermediate store 60 (see FIG. 3), and moreover in the horizontal direction. When being fed in an item is rotated through 90°.

### SUMMARY OF THE INVENTION

It is accordingly an object of the invention to provide a transport device and a transport method which rotate a plurality of transported holding devices which overcome the above-mentioned disadvantages of the prior art methods and devices of this general type, which do not require a holding device to be rotated by a twisted guide device around an axis of rotation parallel to a transportation direction in order to align an article in the enclosed space, and moreover also in the case of holding devices suspended from the guide device.

With the foregoing and other objects in view there is provided, in accordance with the invention a transport device for transporting articles. The transport device contains a plurality of holding devices each having a plurality of delimiting elements which together define an enclosed space. Each of the holding devices are embodied such that a respective holding device is able to accommodate an article to be transported in the enclosed space. A guide device is provided for the holding devices. The transport device is embodied to transport each of the holding devices together with the article contained in the enclosed space in each case along the guide device and rotate the holding devices during transportation along the guide device such that the article accommodated in the enclosed space is aligned with two of the delimiting elements of the holding device due to a force of gravity. The guide device contains a first rotary section and a following second rotary section. The guide device is configured such that each of the holding devices executes a first rotational movement around a first axis of rotation during transportation along the first rotary section and executes a second rotational movement around a second axis of rotation during transportation along the second rotary section. The first axis of rotation does not run parallel to the second axis of rotation, the first axis of rotation stands perpendicularly with respect to a transportation direction in the first rotary section, and the second axis of rotation stands perpendicularly with respect to the transportation direction in the second rotary section.

According to the inventive solution a transport device and a transport method are provided for the purpose of transporting articles.

The transport device contains a plurality of holding devices for receiving and transporting articles. The transport device according to the inventive solution transports a plurality of holding devices along a guide device of the transport device.

Each holding device in each case possesses a plurality of delimiting elements which collectively enclose a space. At least one article that is to be transported can be placed into the enclosed space, and the article can be removed again from the space. The enclosed space is larger in at least one direction than a received article that is to be transported.

The transport device transports each holding device used along a guide device. Placing an article into the holding device and conveying the holding device together with the article along the guide device also causes the article to be transported. The guide device prevents a movement of a holding device perpendicularly to the conveying route or at least delimits such a perpendicular movement within a tolerance.

During transportation along the guide device the holding device is guided along a conveying route.

The guide device contains a first rotary section and a following—viewed in the transportation direction—second rotary section. The conveying route runs through the two rotary sections.

When a holding device is transported through the first rotary section the holding device is rotated around a first axis of rotation. When the holding device is subsequently transported through the second rotary section the holding device is rotated around a second axis of rotation. The second axis of rotation is different from the first axis of rotation and is also not parallel to the first axis of rotation, i.e. the second axis of rotation intersects the first axis of rotation, or the two axes of rotation are skewed relative to each other.

Both the first axis of rotation and the second axis of rotation stand perpendicularly with respect to the respective transportation direction in which a holding device is conveyed during transportation along the first rotary section and the second rotary section respectively.

The force of gravity acts upon an article that is contained in the holding device and transported together with the holding device. The two rotations of the holding device around the two axes of rotation cause the article in the holding device to be aligned by the force of gravity with two delimiting elements of the holding device.

The rotational movements are exerted on an article in the enclosed space of the holding device. As a result the article is aligned within the rotated holding device by the force of gravity. After the holding device has been transported through the second rotary section, the article in the enclosed space has been aligned with two delimiting elements of the holding device by the force of gravity.

During transportation along the guide device a holding device is rotated first around the first axis of rotation and then around the second axis of rotation. Both axes of rotation stand perpendicularly with respect to the current transportation direction in which the holding device is transported through the respective rotary section. By this means the invention enables the article to be reliably aligned in the holding device in accordance with the process without the guide device needing to have a twisted section turned in upon itself. Thanks to the invention the disadvantages of a twisted guide device are avoided, in particular the disadvantages of a more complicated mechanical design.

A rotation around an axis of rotation standing perpendicularly with respect to the transportation direction reduces the risk of a holding device tilting in the event of a rotation during transportation. Moreover, said rotation—viewed in the transportation direction—requires less space than a rotation around a differently oriented axis of rotation.

According to the inventive solution, two rotations are effected in succession around two different axes of rotation. Both the first axis of rotation and the second axis of rotation stand perpendicularly with respect to the current transportation direction in which the holding device is conveyed during transportation through the first rotary section and the second rotary section respectively. This enables the same transport device to be used with the same guide device in order to align different articles having different shapes, dimensions or weights in succession in a holding device in each case. It is not necessary to measure a parameter of the article for alignment purposes.

The same holding device of the transport device can transport articles of different dimensions simultaneously or in succession provided the holding device is larger in size than any of the articles. As a result a transport device having a plurality of uniform holding devices can be realized, and each article to be transported can be placed into any available holding device.

The invention enables driveless holding devices to be used, in other words a holding device can be used without a rotary device. Such a rotary device would have to be transported as a component part of the holding device and actively rotate a holding device. In particular the holding devices need no dedicated drive of their own in order to be transported and rotated and in order in so doing to align articles in the enclosed space in each case.

It is however also possible for each holding device to possess its own dedicated drive. The guide device guides the holding devices provided with their own drive along a conveying route in the manner of rail vehicles. This embodiment economizes on a transmission means which connects a central drive to the holding devices.

Thanks to the invention the article which has been aligned in the driveless holding device or holding device provided with its own dedicated drive can be placed into another container, in particular as a result of the article sliding out of the holding device into the container. Thanks to the inventively achieved alignment the position that the article will reach in the container can be predicted and controlled, even when the article is transferred out of the moving holding device into the stationary container.

The invention enables an article to be transferred out of the holding device into a container that is open at the top, e.g. by the article sliding out of the holding device into the container. This type of transfer requires only a very simple actuating device because use is made of the force of gravity. Thereafter the article lies or stands on a floor of the container. The floor of the container is larger than the article so that the article will in any event lie flat on the floor. Thanks to the invention it is made possible to align the article in the holding device and to place the aligned article into the container in such a way that the article subsequently arrives at a defined position in the container, e.g. aligned with two sidewalls of the container. This enables a stack composed of a plurality of articles to be produced in the container, the stack being amenable to efficient further processing.

In one embodiment the transport device is implemented in such a way that a holding device executes a rotational movement around the first axis of rotation solely when the holding device is conveyed through the first rotary section.

In another embodiment the holding device additionally executes another movement, e.g. a linear movement, while it is being transported through the first rotary section. The other movement and the rotational movement overlap each other.

In one embodiment the transport device is implemented in such a way that a holding device executes a rotational movement around the second axis of rotation solely when the holding device is transported through the second rotary section. A clearance can appear between the first axis of rotation and the rotated holding device such that when being conveyed along the first rotary section the holding device passes through a segment of a circle or an ellipse.

In another embodiment the holding device additionally executes another movement while it is being transported through the second rotary section. The other movement and the rotational movement overlap each other while the holding device is being conveyed through the second rotary section. The second axis of rotation is therefore moved while the holding device is transported by the other movement. The second axis of rotation can be moved together with the holding device while the holding device is being transported through the second rotary section, and run through the transported holding device, in other words moved at the same speed as the holding device.

In this other embodiment the conveying route of a holding device which passes through the second rotary section preferably extends in one plane. The conveying route during the passage through the second rotary section is e.g. a segment of a circle or an ellipse. This embodiment leads to a particularly smooth, virtually jerk-free transportation of the holding device.

In one embodiment a guide device induces a forced guidance of a holding device while the holding device is transported initially through the first rotary section and then through the second rotary section and in so doing is rotated in turn firstly around the first axis of rotation and then around the second axis of rotation. The forced guidance causes a holding device to be rotated initially around the first axis of rotation and then around the second axis of rotation while the holding device is conveyed through the two rotary sections.

This embodiment can be combined both with an embodiment variant in which a central drive moves the driveless holding devices and with an embodiment variant in which each holding device has its own dedicated drive. The forced guidance avoids the necessity of having to equip a holding device with a separate actuating device of its own in order to effect the rotations around the two axes of rotation.

In a preferred embodiment the first axis of rotation stands perpendicularly on the second axis of rotation. In this embodiment a particularly good alignment of the article in the holding device is affected because two rotational movements around two axes of rotation which stand perpendicularly on each other are executed in succession. It is also possible for the first axis of rotation to intersect the second axis of rotation—or a projection of the second axis of rotation onto the first axis of rotation—at a different angle, e.g. at an angle between 45 degrees and 90 degrees.

In one embodiment a holding device, when conveyed along the guide device, passes through:

an incoming section, in which the holding device is transported linearly and without rotation,

a first transitional section, in which the holding device is rotated around the first axis of rotation and which acts as the first rotary section,

the second rotary section, in which the holding device is rotated around the second axis of rotation,

a second transitional section, in which the holding device is rotated around an axis of rotation parallel to the first axis of rotation, and

an outgoing section, in which the holding device is in turn conveyed linearly and without rotation.

Preferably the holding device is rotated in the first rotational direction in the first transitional section and in the rotational direction opposite the first rotational direction in the second transitional section. The two angles of rotation during the rotation in the two transitional sections are preferably equal in size.

The conveying route is preferably embodied as a closed-loop conveying route. At least one central drive moves the holding devices preferably consistently in the same direction along the closed-loop conveying route. Alternatively each holding device has its own dedicated drive. The closed-loop conveying route enables transportation without reversal of direction to be achieved, resulting in less wear and tear.

In a preferred embodiment the holding devices are transported continuously in one direction along the conveying route, in other words without a start-stop mode of operation (“indexing”) being executed. An article in the enclosed space is aligned while the holding device containing the article is being transported and during transportation is rotated in turn around the two axes of rotation. This embodiment leads to a higher throughput and nonetheless effects an alignment of the articles in the holding devices.

In an embodiment the conveying device is implemented in such a way that the holding devices are transported along a closed-loop conveying route, e.g. consistently in one transportation direction along a closed curve.

In an embodiment a central drive moves the holding devices along the preferably closed-loop conveying route. The central drive obviates the necessity of having to provide each holding device with its own dedicated local drive. The holding devices can be built to a simple and lightweight design because they frequently have no drives.

It is however also possible for each holding device to have its own dedicated drive. This eliminates the need to provide a central drive and transmission device between the central drive and the holding devices. In this embodiment, too, a guide device affects a forced guidance of each holding device.

In an embodiment each holding device is implemented for the purpose of transporting at least one flat article in each case. A flat article is placed into the enclosed space of a holding device defined by the delimiting elements. The enclosed space extends in an article plane. The transport device transports the holding device in such a way that the article plane of the enclosed space always stands perpendicularly with respect to the current transportation direction in which the holding device is transported. At least one delimiting element also extends in the article plane. This embodiment leads to a high packing density, i.e. requires less space viewed in the transportation direction, and enables numerous holding devices to be transported in each section of the guide device, including holding devices having different dimensions. The different dimensions have an effect only in a plane at right angles to the transportation direction.

In a development of this embodiment each holding device has two sidewalls and at least two connecting elements which connect the sidewalls to each other on two sides in each case. The two connecting elements act as the floor and as a narrower lateral delimiting surface of the enclosed space, the two sidewalls acting as the two wider lateral delimiting surfaces. An article is aligned with the two connecting elements by the force of gravity.

In an embodiment each holding device has an unloading mechanism which can be placed into an open and into a closed position. When the unloading mechanism is in the closed position, an article remains in the enclosed space of the holding device and the holding device can be transported together with the article. If the unloading mechanism is opened, the article slides downward out of the holding device due to the force of gravity. The transport device is embodied such that the unloading mechanism will be opened after the holding device has been transported along the two rotary sections and the article has been aligned in the enclosed space as a result of the two rotations.

Because the article has been aligned before it slides out of the holding device process reliability during transportation is increased. In particular the position at which the downward-sliding article will strike another component part of the transport device or another article that is to be transported can be predicted with greater accuracy. The unloading mechanism contains for example a flap or even two flaps which open and close in the manner of single-leaf or double-leaf door.

In an embodiment each holding device is suspended from a component part of the guide device. The transported holding device containing the article is aligned by the force of gravity before, during and after the rotations and in addition the article in the holding device is aligned within the enclosed space in the same way. This embodiment furthermore makes it easier to remove the article from the enclosed space. It is made possible for the article to slide downward. A gripper tool for extracting or pulling the article out of the holding device is not necessary. A tilting device for tilting the filled holding device is also not required.

The transport device according to the inventive solution can be used in a sorting system which sorts a plurality of articles as a function of a predefined sorting criterion. The sorting system possesses a plurality of sorting terminal stations as well as an inventive transport device having a plurality of holding devices. The articles are sorted in that the sorting system distributes the articles to sorting terminal stations of the sorting system as a function of the sorting criterion values of the articles.

A selection unit selects a sorting terminal station as a function of the sorting criterion value of an article that is to be sorted. A loading station loads a holding device of the inventive transport device in each case with at least one article that is to be sorted. Preferably a first measurement is taken to determine which value the sorting criterion will assume for an article that is to be sorted, and then the article is placed into a holding device. The sorting system transports each article to respectively selected sorting terminal stations, for which purpose the sorting system uses the inventive transport device. On its way to the selected sorting terminal station an article that is to be sorted is located at least temporarily in a holding device of the inventive transport device.

The invention can be used in a sorting method which sorts articles according to a predefined sorting criterion. During the sorting the below described steps are performed for each article.

A measurement is taken to determine which value the sorting criterion will assume for said article.

A sorting terminal station is selected for the article as a function of the measured sorting criterion value.

The article is placed into the enclosed space of a holding device of the transport device.

The holding device containing the article is transported along the conveying route. During the transportation the article is aligned in the enclosed space.

The aligned article is subsequently removed again from the holding device.

In an embodiment the article is placed into a temporary buffer store.

The article is placed into or onto the selected sorting terminal station, and moreover either directly from the holding device or from the temporary buffer store into the sorting terminal station.

Other features which are considered as characteristic for the invention are set forth in the appended claims.

Although the invention is illustrated and described herein as embodied in a transport device and a transport method which rotate a plurality of transported holding devices, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, plan view of a sorting system according to the invention;

FIG. 2 is a perspective view of a holding device in the form of a storage pocket containing a flat mail item that is not yet aligned;

FIG. 3 is a side view of a storage pocket, a stationary temporary buffer store and a container;

FIG. 4 is a perspective view of an inventive transport device from FIG. 1 in which the second axis of rotation lies approximately in the drawing plane;

FIG. 5 is a perspective view of the transport device from FIG. 1 in which the second axis of rotation stands approximately perpendicularly on the drawing plane;

FIG. 6 is a sectional view of five storage pockets in the two rotary sections taken along the plane II-II shown in FIG. 1; and

FIG. 7 is an illustration showing a tilted storage pocket when passing through the second rotary section.

### DETAILED DESCRIPTION OF THE INVENTION

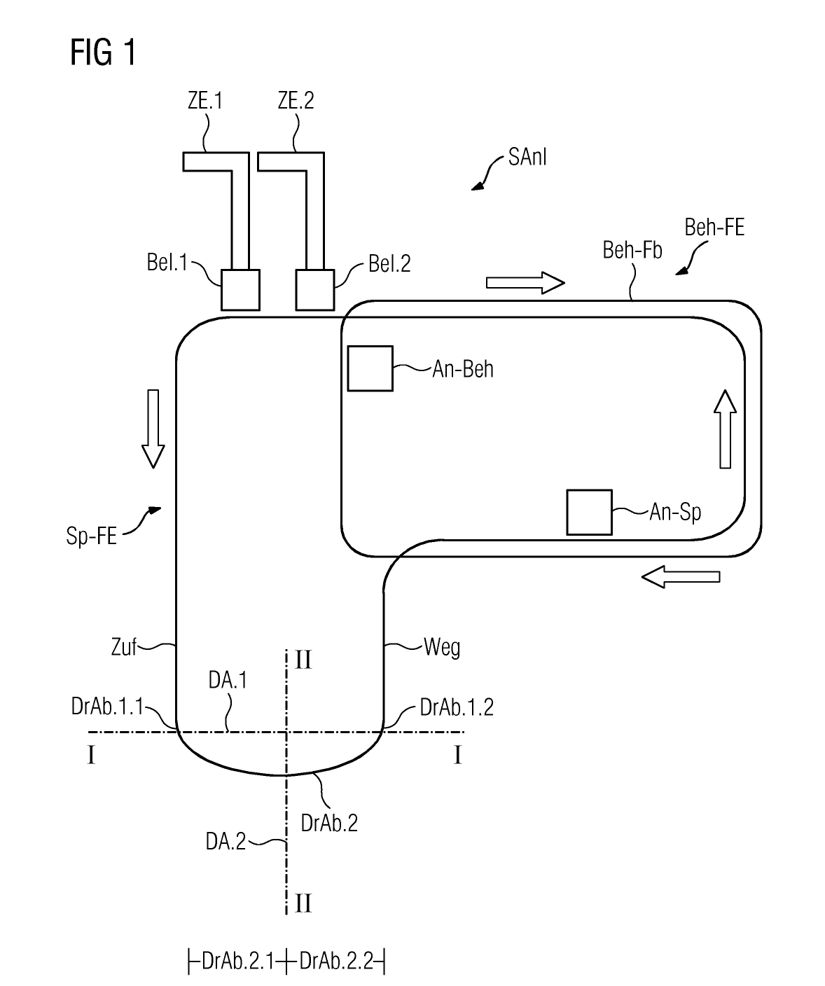

Referring now to the figures of the drawing in detail and first, particularly, to FIG. 1 thereof, there is shown an exemplary embodiment of the invention deployed in a sorting system which sorts flat mail items. Each flat mail item extends in an article plane. The sorting system used possesses a plurality of driveless holding devices in the form of storage pockets (“pockets”) for one flat mail item in each case.

FIG. 1 schematically shows the sorting system in a plan view. Depicted in the figure are:

a storage pocket guide device Sp-FE which conducts storage pockets along an endless closed-loop conveying route and holds the storage pockets,

a central drive An-Sp for the driveless storage pockets,

a container conveying device Beh-FE having a horizontal container conveying route Beh-Fb and a central drive An-Beh for the container conveying route Beh-Fb, and

two feed devices ZE.1, ZE.2 operating in parallel.

The two feed devices ZE.1, ZE.2 singulate mail items. A stream of singulated mail items is transported to each of the two loading stations Bel.1, Bel.2 operating in parallel. Each loading station Bel.1, Bel.2 selects a previously free storage pocket and pushes a mail item into the selected storage pocket. The selected storage pocket is transported by the container conveying device Sp-FE past the two loading stations Bel.1, Bel.2. In the process the mail item is pushed into the storage pocket by a horizontal linear movement, while the storage pocket is transported past the loading station Bel.1, Bel.2 without being delayed or indeed stopped.

The respective transportation direction in which the storage pockets are transported along the endless closed-loop conveying route is indicated in FIG. 1 by two arrows.

The container conveying device Beh-FE transports containers which are open at the top and stand on the container conveying route Beh-Fb. The transportation direction of the container conveying device Beh-FE is likewise indicated by two arrows in FIG. 1.

In the exemplary embodiment the storage pockets and the containers are transported in opposite transportation directions (see FIG. 1). In a variant the storage pockets are transported in the same transportation direction as the containers. The transportation speed of the storage pockets and the transportation speed of the containers can be the same or different.

The storage pockets are transported in the manner of a train so that no storage pocket can overtake another storage pocket. The storage pockets are connected to one another by a sequence of connecting devices, e.g. chains.

In the exemplary embodiment the endless closed-loop conveying route along which the storage pockets are transported contains, in the following order:

an incoming section Zuf,

a first transitional rotary section DrAb.1.1, a second rotary section DrAb.2 having two partial rotary sections DrAb.2.1, DrAb.2.2,

a second transitional rotary section DrAb.1.2, and

an outgoing section Weg.

Located between the incoming section Zuf and the first partial rotary section DrAb.2.1 of the second rotary section DrAb.2 is the first transitional rotary section DrAb.1.1. The second transitional rotary section DrAb.1.2 is located between the second partial rotary section DrAb.2.2 of the second rotary section DrAb.2 and the outgoing section Weg.

On its way along the closed-loop conveying route each storage pocket passes, inter alia, through:

firstly the incoming section Zuf,

then the first transitional rotary section DrAb.1.1,

then the two partial rotary sections DrAb.2.1, DrAb.2.2 in turn,

then the second transitional rotary section DrAb.1.2, and

then the outgoing section Weg.

In the exemplary embodiment the incoming section Zuf and the outgoing section Weg extend horizontally and lie in the drawing plane of FIG. 1. During transportation through the incoming section Zuf and through the outgoing section Weg each storage pocket is transported linearly, without being rotated around an axis of rotation which stands perpendicularly on the article plane of a mail item in the storage pocket.

In the exemplary embodiment each storage pocket, during transportation through the first transitional rotary section DrAb.1.1 and through the second transitional rotary section DrAb.1.2, traverses in each case a transport path in the form of a segment of a circle or an ellipse, and moreover during each passage through the transitional rotary section. In the exemplary embodiment the circle or the ellipse lies in a plane standing perpendicularly on the horizontal. Both during transportation through the first transitional transport section DrAb.1.1 and through transportation through the second transitional rotary section DrAb.1.2 each storage pocket is rotated around a first axis of rotation DA.1 which lies in the drawing plane of FIG. 1 and stands perpendicularly with respect to the transportation direction. Each storage pocket is therefore rotated twice in succession around the same axis of rotation DA.1, and moreover in different rotational directions and approximately through the same angle of rotation.

In the exemplary embodiment each storage pocket, during transportation through the second rotary section DrAb.2, likewise traverses a transport path in the form of a segment of a circle or an ellipse, said circle or ellipse lying in a plane standing obliquely on the horizontal and obliquely on the vertical. Preferably the plane stands an angle on the horizontal that lies between 30 degrees and 60 degrees. During transportation through the second rotary section DrAb.2 each storage pocket completes a linear movement and a rotational movement. The two movements overlap each other. The axis of rotation DA.2 of the rotation during transportation through the second rotary section DrAb.2 also lies in the drawing plane of FIG. 1 and stands perpendicularly with respect to the transportation direction and perpendicularly on the first axis of rotation DA.1. The second axis of rotation DA.2 is moved as well, and moreover linearly, during transportation of the storage pocket.

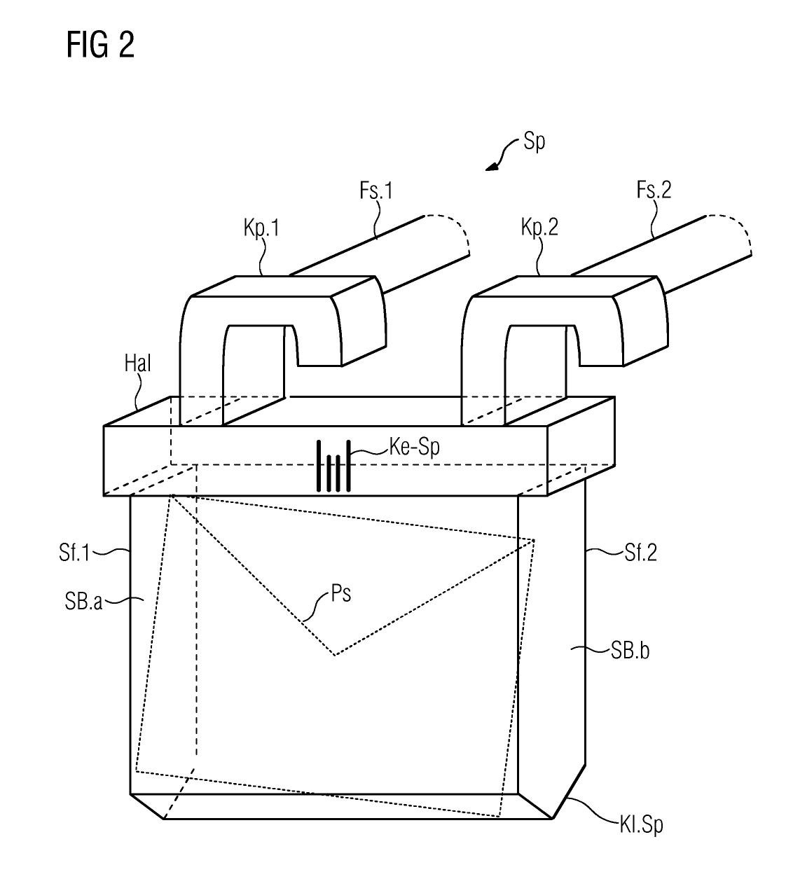

FIG. 2 schematically shows a holding device in the form of a storage pocket Sp containing a flat mail item Ps. A train composed of a plurality of storage pockets of the type is conducted along the closed-loop conveying route by the storage pocket guide device Sp-FE. The storage pockets have no dedicated drive of their own. Instead the central drive An-Sp pulls or pushes the storage pockets along the closed-loop conveying route, and moreover with the aid of a transmission device, e.g. by a chain or a sequence of chains. The storage pockets are held on the closed-loop conveying route by the storage pocket guide device Sp-FE. In the exemplary embodiment the storage pocket guide device Sp-FE contains two parallel guide rails Fs.1, Fs.2.

The storage pocket Sp of FIG. 2 holds an upright mail item Ps between two parallel level lateral surfaces Sf.1, Sf.2 which are mechanically connected to each other. The mail item has not yet been aligned. A mail item can be inserted into the storage pocket Sp from the side. On the floor the storage pocket Sp has a pivotable flap Kl.Sp having two leaves. With flap Kl.Sp closed, the storage pocket Sp holds the mail item Ps. With flap Kl.Sp open, the mail item Ps slides downward out of the storage pocket Sp due to the force of gravity. The two leaves of the flap Kl.Sp are each rotatable around an axis of rotation. The two axes of rotation extend parallel to the drawing plane of FIG. 2.

In FIG. 2, two lateral delimiting elements SB.a, SB.b are indicated which are joined to the two lateral surfaces Sf.1, Sf.2. In the exemplary embodiment one lateral delimiting element SB.a or SB.b can be opened and closed, e.g. by compressing or stretching the storage pocket Sp. Alternatively a lateral delimiting element SB.a, SB.b has an opening through which a mail item can be pushed. A mail item can be pushed into the enclosed space through the open lateral delimiting element SB.a or SB.b. In an embodiment only one lateral delimiting element can be opened or has an opening, while the other lateral delimiting element is permanently closed.

The two lateral surfaces Sf.1, Sf.2 are suspended from a mount Hal. A machine-readable identifier Ke-Sp having e.g. the form of a line pattern (“bar code”) is applied to the mount Hal. The identifier Ke-Sp distinguishes the storage pocket Sp from all other storage pockets of the sorting system SAnI.

The storage pocket Sp is suspended from the two parallel guide rails Fs.1, Fs.2, and moreover by two corresponding coupling elements Kp.1, Kp.2 embodied e.g. in the shape of hooks. The coupling element Kp.1 slides along the guide rail Fs.1, while the coupling element Kp.2 slides along the guide rail Fs.2. The coupling is embodied in such a way that the filled storage pocket Sp is obliged to follow a rotation or inclination of the guide rails Fs.1, Fs.2, as will be explained further below. A non-illustrated guiding element prevents the corresponding coupling element Kp.1, Kp.2 from detaching itself from the respective guide rail FS.1, FS.2.

The sorting system sorts articles according to a predefined sorting criterion. In the exemplary embodiment the articles that are to be sorted are flat mail items. In one embodiment the delivery address to which a mail item that is to be sorted is to be transported is used as the sorting criterion. A reader device of the sorting system reads the respective delivery address identification code on each mail item. In another embodiment the sorting system sorts the mail items according to a different measurable sorting criterion, e.g. according to a dimension or the weight.

The sorting system applies a computer-executable sorting plan. The sorting plan assigns a sorting terminal station in each case to each sorting criterion value occurring (in the exemplary embodiment: the respective delivery address of a mail item that is to be sorted).

In the exemplary embodiment the flat mail items are allocated to containers as a function of the sorting plan. A full container is replaced by an empty container.

In one embodiment the containers are implemented as stationary. Each container stands e.g. on a supporting surface. A filled container can be taken from the supporting surface and replaced by an empty container.

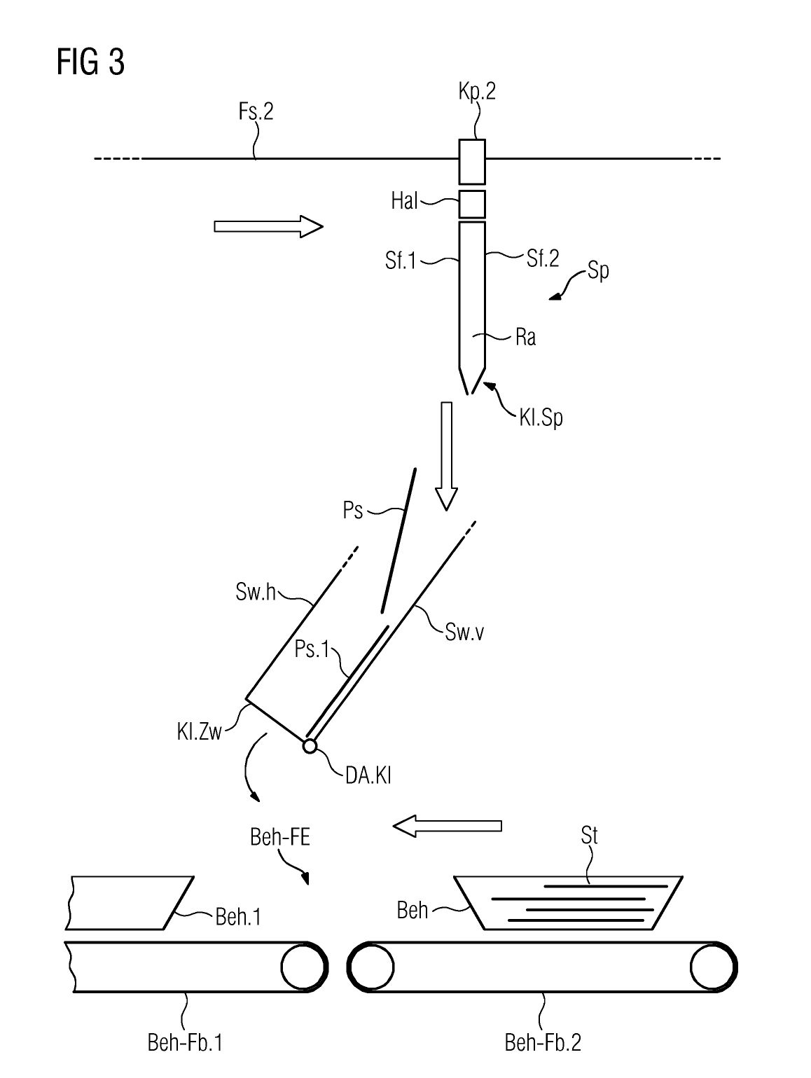

In another embodiment, shown in FIG. 1 and FIG. 3, the containers stand on the horizontal conveyor belt Beh-Fb of the container conveying device Beh-FE. The containers are open at the top and stand on the horizontal conveyor belt Beh-Fb. The containers are transported by the container conveying device Beh-FE along an endless conveying route. In both cases the container positions and undefined containers act as sorting terminal stations. In one embodiment each container is transported on the container conducting device Beh-FE in such a way that the floor of the container—viewed in the transportation direction—is inclined sloping obliquely downward toward the front. This results in mail items in the container sliding forward and being aligned with the front sidewall.

The sorting system performs the following steps for each mail item:

The mail item is transported—together with other mail items—to a feed device ZE.1, ZE.2.

A singulator of a feed device ZE.1, ZE.2 separates the mail item. A stream of mail items arranged in an upright position leaves each singulator.

A reader device deciphers the delivery address on the mail item transported in an upright position.

The feed device ZE.1, ZE.2 transfers the mail item transported in an upright position to a loading station Bel.1, Bel.2.

The loading station Bel.1, Bel.2 transfers the upright mail item into a previously empty storage pocket Sp.

The now filled storage pocket Sp is transported along the closed-loop conveying route of the storage pocket guide device Sp-FE.

The flap Kl.Sp of the storage pocket Sp is opened as soon as the storage pocket Sp is located in a transfer position relative to a stationary temporary buffer store. The stationary temporary buffer store was selected automatically with the aid of the sorting plan and is located—together with many other stationary temporary buffer stores—in a plane between the plane with the storage pocket guide device SP-FE and the storage pockets and the container conveying device Beh-FE.

A container which is transported on the horizontal conveyor belt Beh-Fb along the closed-loop conveying route assumes a transfer position relative to the stationary temporary buffer store. In the transfer position the transported container is located obliquely below the stationary temporary buffer store containing the mail item. A flap on the floor of the temporary buffer store is opened and the mail item slides out of the temporary buffer store downward into the container. The container reaches a position vertically below the temporary buffer store as soon as the falling mail item reaches the container.

FIG. 3 illustrates how a mail item passes from a storage pocket Sp into a container Beh. The container Beh and the previous container Beh.1—viewed in the transportation direction of the container conveying device Beh-FE—are transported by the container conveying device Beh-FE. FIG. 3 shows two horizontal endless conveyor belts Beh-Fb.1, Beh-Fb.2 of the container conveying device Beh-FE which transport the containers Beh, Beh.1. A stack St composed of horizontally oriented mail items has already been formed in the container Beh.

Initially the mail item Ps was located in the storage pocket Sp. The filled storage pocket Sp is suspended by means of its two coupling elements Kp.1, Kp.2 from the guide rails Fs.1, Fs.2. In the situation shown in FIG. 3 the flap Kl.Sp has been opened and the mail item Ps is in free fall due to the force of gravity.

In the situation shown in FIG. 3 the mail item Ps is in the process of sliding out of the storage pocket Sp into the stationary temporary buffer store ZwSp. The stationary temporary buffer store ZwSp has the shape of a pocket having a higher sidewall Sw.v at the front and a lower sidewall Sw.h at the rear. “Front” and “rear” refers to the transportation direction of the storage pocket Sp. A flap Kl.Zw on the floor of the stationary temporary buffer store ZwSp is still closed and can be opened under control. The flap Kl.Zw is rotatably mounted around the axis of rotation DA.kl. The axis of rotation DA.kl stands perpendicularly on the drawing plane of FIG. 3. With flap Kl.Zw open, the mail item Ps slides out of the temporary buffer store ZwSp downward into the container Beh and comes to rest there on the already formed stack St.

In the exemplary embodiment the storage pockets and the containers are transported in opposite directions, while the temporary buffer stores are stationary. In FIG. 1 and FIG. 3 the opposing transportation directions in which the storage pockets and the containers are transported are indicated by arrows.

In spite of the free fall into the container Beh, the different-sized flat mail items are intended to be stacked in an ordered manner in the container Beh. This requires the mail items to be buffered in aligned fashion in the temporary buffer store ZwSp—in spite of the free fall into the temporary buffer store ZwSp. This in turn makes it necessary to align each mail item Ps in the storage pocket Sp used in each case before the mail item slides out of the storage pocket, and moreover with a floor and at a sidewall of the storage pocket Sp. FIG. 2 shows a mail item in a storage pocket Sp before the mail item Ps has been aligned in the storage pocket Sp.

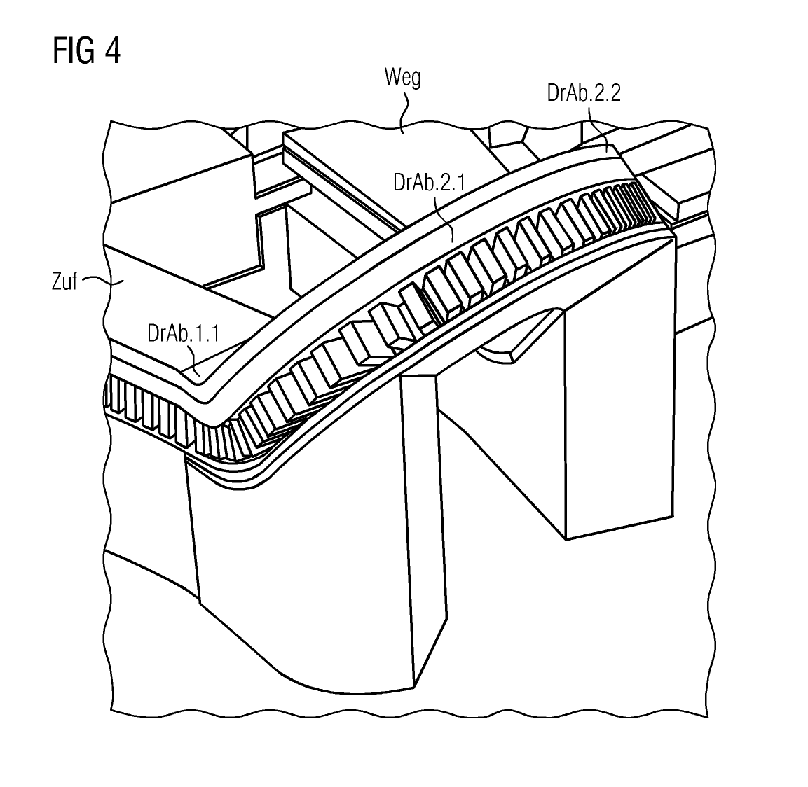

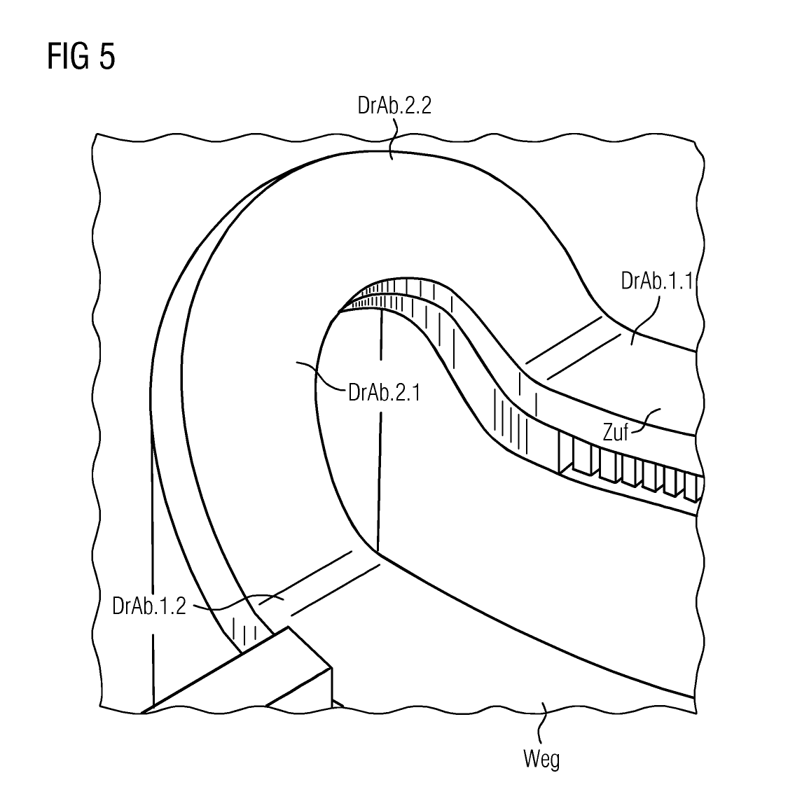

FIG. 4 and FIG. 5 show two perspective views of the rotary sections from different observation directions. The observation direction of FIG. 4 extends approximately parallel to the plane in which the second rotary section DrAb.2 lies. The second axis of rotation DA.2 lies approximately in the drawing plane of FIG. 4. What can be seen are

a larger part of the second rotary section DrAb.2,

several storage pockets in said second rotary section DrAb.2,

the first transitional rotary section DrAb.1.1,

the incoming section Zuf, and

the outgoing section Weg.

In FIG. 5 the plane of the second rotary section DrAb.2 lies approximately in the drawing plane. The first axis of rotation DA.1 lies approximately in the drawing plane of FIG. 5. What can be seen are

both transitional rotary sections DrAb.1.1, DrAb.1.2,

the second rotary section DrAb.2,

the incoming section Zuf, and

the outgoing section Weg.

In FIG. 5 the coupling elements of a storage pocket point toward the observer while the storage pocket passes through the second rotary section DrAb.2.

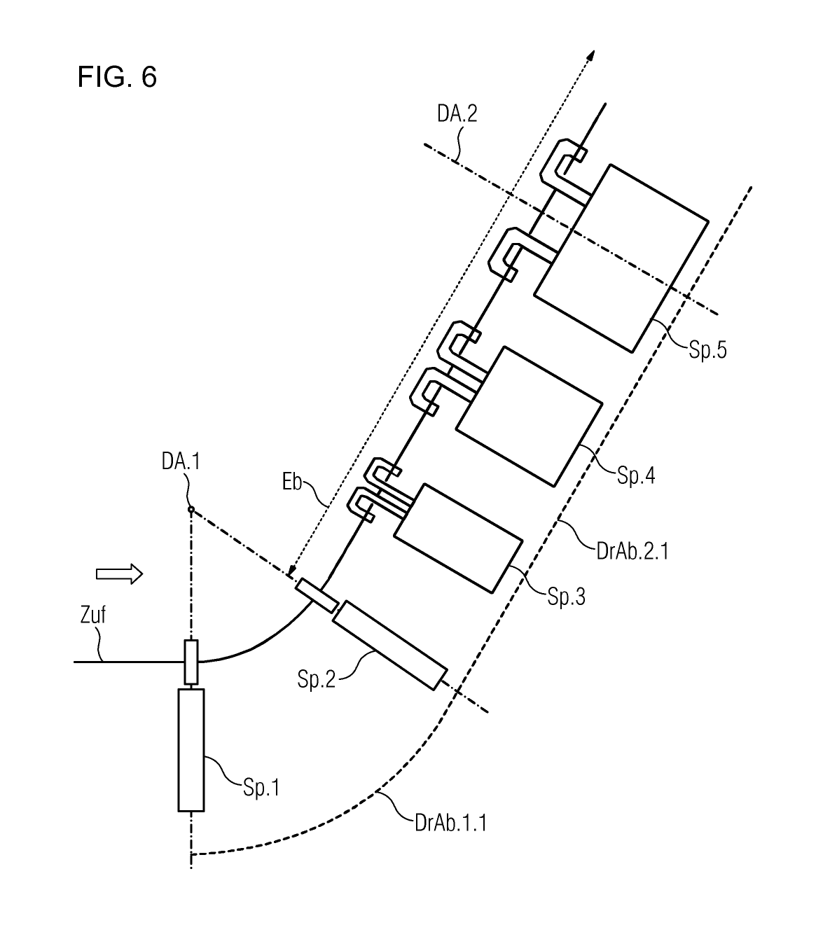

A mail item is aligned in the storage pocket while the storage pocket Sp containing the mail item Ps is transported through the first transitional rotary section DrAb.1.1 and the second rotary section DrAb.2. FIG. 6 shows the first transitional rotary section DrAb.1.1 and the first partial rotary sections DrAb.2.1 in the plane II-II of FIG. 1. The incoming section Zuf and the outgoing section Weg lie in the drawing planes of FIG. 1 and FIG. 6.

An oblique plane Eb is indicated in FIG. 6. The conveying route passed through by a coupling element of a storage pocket during transportation along the second rotary section DrAb.2 lies in the plane Eb. The plane Eb stands perpendicularly on the drawing plane of FIG. 6 and is inclined toward the horizontal by an angle lying between 30 degrees and 60 degrees.

During its passage through the first transitional rotary section DrAb.1.1 a storage pocket is rotated around the first axis of rotation DA.1, which stands perpendicularly on the drawing plane of FIG. 6. The storage pocket Sp.1 will shortly pass through the first transitional rotary section DrAb.1.1. The storage pocket Sp.2 has already passed through the first transitional rotary section DrAb.1.1. A comparison of the storage pockets Sp.1 and Sp.2 illustrates how a storage pocket is rotated around the first axis of rotation DA.1 during its passage through the first transfer rotary section DrAb.1.1. The article plane of a mail item in the storage pockets Sp.1, Sp.2 stands perpendicularly on the drawing plane of FIG. 1.

In the example of FIG. 6 a storage pocket, when passing through the first transitional rotary section DrAb.1.1, is rotated solely around the first axis of rotation DA.1, but in particular is not transported linearly. In the example of FIG. 6 a clearance occurs between the first axis of rotation DA.1 and the rotated storage pocket during the rotation with the result that during the rotation the storage pocket passes through a segment of a circle or an ellipse.

The storage pockets Sp.3, Sp.4, Sp.5 are in the process of passing through the second rotary section DrAb.2 and in so doing are rotated around the second axis of rotation DA.2 and also transported along the plane Eb. The second axis of rotation DA.2 lies in the drawing plane of FIG. 6 and in the exemplary embodiment stands perpendicularly on the first axis of rotation DA.1 and stands perpendicularly on the plane Eb. Both axes of rotation DA.1, DA.2 stand perpendicularly with respect to the current transportation direction in which a storage pocket is being transported. During the passage of a storage pocket through the transitional rotary section DrAb.1.1 the current transportation direction lies in the drawing plane of FIG. 6 and during the passage through the second rotary section DrAb.2 runs parallel to the plane Eb. A comparison of the four storage pockets Sp.2, . . . , Sp.5 illustrates how a storage pocket is rotated around the second axis of rotation DA.2.

In the example of FIG. 6 the second axis of rotation DA.2, around which a storage pocket is rotated during its transportation along the second rotary section DrAb.2, is displaced linearly, namely in a direction parallel to the plane Eb. In the example of FIG. 6 the accompanying second axis of rotation DA.2 runs centrally through the storage pocket.

During the entire transportation along the closed-loop conveying route the article planes of the lateral surfaces Sf.1, Sf.2 of the storage pocket Sp and the flat mail item Ps in the storage pocket Sp stand perpendicularly on the vector of the current transportation direction, including during transportation along the rotary sections DrAb.1.1, DrAb.1.2, DrAb.2. During transportation along the closed-loop conveying route this transportation direction changes whenever the storage pocket passes through a rotary section DrAb.1.1, DrAb.1.2, DrAb.2 (see FIG. 1).

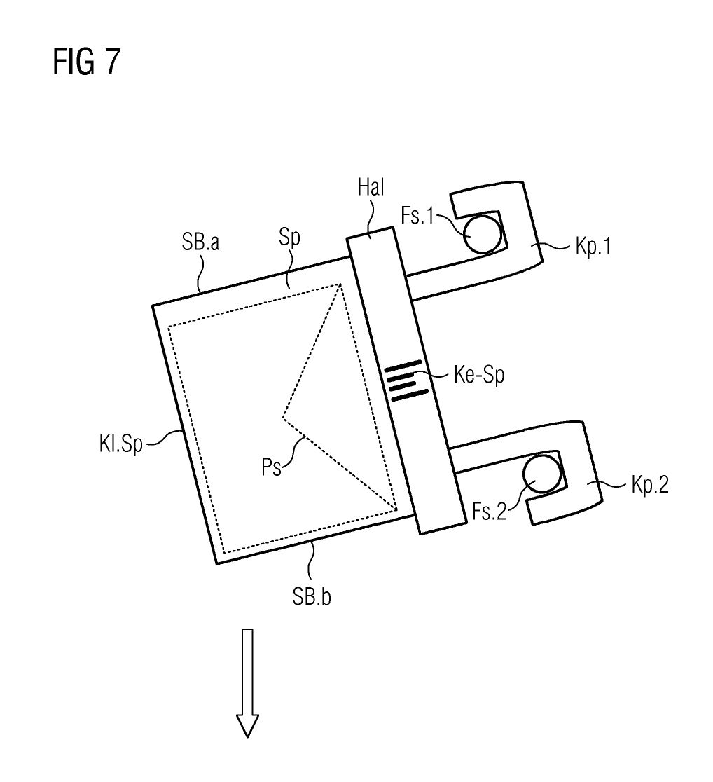

FIG. 7 shows how the storage pocket Sp has been rotated around an axis of rotation, the axis of rotation standing perpendicularly on the drawing plane of FIG. 7. The mail item Ps is aligned as desired on the floor and with the now lower sidewall of the storage pocket Sp by the force of gravity.

### LIST OF REFERENCE SIGNS

| Reference sign | Meaning |
|---|---|
| An-Beh | Drive for the container conveying device Beh-FE |
| An-Sp | Central drive for the storage pockets Sp, Sp.1, Sp.2, . . . |
| Beh | Container for flat mail items, stands on the container |
| | conveying device Beh-FE |
| Beh.1 | Further container for flat mail items |
| Beh-Fb | Horizontal container conveying route of the container |
| | conveying device Beh-FE |
| Beh-Fb.1, | Horizontal endless conveyor belts of the container |
| Beh-Fb.2 | conveying device Beh-FE, carry the containers Beh and |
| | Beh.1 respectively |
| Beh-FE | Container conveying device |
| Bel.1, Bel.2 | Loading stations, place flat mail items into storage |
| | pockets |
| DA.1 | First axis of rotation - axis of rotation around which |
| | the storage pocket is rotated during its passage through |
| | the first transitional rotary section DrAb.1.1 and through |
| | the second transitional rotary section DrAb.1.2 |
| DA.2 | Second axis of rotation - axis of rotation around which |
| | the storage pocket is rotated during its passage through |
| | the second rotary section DrAb.2 |
| DA.Kl | Axis of rotation about which the flap Kl.Zw is rotatably |
| | mounted |
| DrAb.1.1 | First transitional rotary section, acts as the first |
| | rotary section |
| DrAb.1.2 | Second transitional rotary section |
| DrAb.2 | Second rotary section |
| DrAb.2.1, | Partial rotary sections of the second rotary section |
| DrAb.2.2 | DrAb.2 |
| Eb | Oblique plane in which the transportation route of the |
| | storage pocket Sp.1, Sp.2, . . . lies during transportation |
| | through the second rotary section DrAb.2 |
| Fs.1, Fs.2 | Guide rails of the storage pocket conveying device Sp-FE |
| Hal | Mount for the two lateral surfaces Sf.1, Sf.2 of the |
| | storage pocket Sp |
| Ke-Sp | Machine-readable identifier on the mount Hal of the |
| | storage pocket Sp |
| Kl.Sp | Flap in the floor of the storage pocket Sp |
| Kl.Zw | Flap on the floor of the stationary temporary buffer |
| | store ZwSp |
| Kp.1, Kp.2 | Coupling elements of the storage pockets Sp |
| Ps | Mail item in the storage pocket Sp |
| SAnl | Sorting system having holding devices in the form of |
| | storage pockets |
| SB.a, SB.b | Lateral delimiting elements of the storage pocket Sp |
| Sf.1, Sf.2 | Lateral surfaces of the storage pocket Sp |
| Sp-FE | Storage pocket guide device |
| Sp | Driveless storage pocket which transports the mail |
| | item Ps |
| Sp, Sp.1, | Further holding devices in the form of driveless storage |
| Sp.2, . . . | pockets |
| St | Stack composed of flat mail items in the container Beh |
| Sw.h | Rear sidewall of the stationary temporary buffer store |
| | ZwSp |
| Sw.v | Front sidewall of the stationary temporary buffer store |
| | ZwSp |
| Weg | Outgoing section through storage pockets are transported |
| | without being rotated |
| ZE.1, ZE.2 | Feed devices |
| Zuf | Incoming section through which storage pockets are |
| | transported without being rotated |
| ZwSp | Stationary temporary buffer store |

1. A transport device for transporting articles, the transport device comprising:
a plurality of holding devices each having a plurality of delimiting elements which together define an enclosed space, each of said holding devices embodied such that a respective said holding device is able to accommodate an article to be transported in the enclosed space; and
a guide device for said holding devices, the transport device embodied to transport each of said holding devices together with the article contained in the enclosed space in each case along said guide device and rotate said holding devices during transportation along said guide device such that the article accommodated in the enclosed space is aligned with two of said delimiting elements of said holding device due to a force of gravity, said guide device containing a first rotary section and a following second rotary section, said guide device such that each of said holding devices executes a first rotational movement around a first axis of rotation during transportation along said first rotary section and executes a second rotational movement around a second axis of rotation during transportation along said second rotary section, wherein the first axis of rotation does not run parallel to the second axis of rotation, the first axis of rotation standing perpendicularly with respect to a transportation direction in said first rotary section, and the second axis of rotation stands perpendicularly with respect to the transportation direction in said second rotary section.

2. The transport device according to claim 1, wherein the first axis of rotation stands perpendicularly on the second axis of rotation.

3. The transport device according to claim 1, wherein said enclosed space of said respective holding device extends in an article plane and both the first axis of rotation and the second axis of rotation lie in the article plane.

4. The transport device according to claim 1, wherein the enclosed space of said respective holding device extends in an article plane and the transport device is embodied to transport each of said holding devices along said guide device such that a current transportation direction in which said respective holding device is being transported stands perpendicularly on the article plane of the enclosed space.

5. The transport device according to claim 1, wherein the transport device is embodied such that a transportation route over which said respective holding device passes during transportation along said second rotary section has a shape of a segment of a circle or a segment of an ellipse, said segment lying in a plane which is inclined obliquely toward a horizontal.

6. The transport device according to claim 1, wherein the transport device is embodied such that a transportation route over which said respective holding device passes during transportation along said first rotary section has a shape of a segment of a circle or a segment of an ellipse, said segment lying in a plane which stands perpendicularly on the horizontal.

7. A method for transporting a plurality of articles using a transport device having a plurality of holding devices and a guide device, wherein each of the holding devices in each case has a plurality of delimiting elements which together define an enclosed space, which comprises the following steps performed for each of the articles:
placing an article into one of the holding devices such that the article is accommodated by the enclosed space;
transporting the holding device with the article along the guide device and being guided by the guide device, wherein a guided transportation of the holding device along the guide device causes the holding device to be rotated such that the article contained in the enclosed space is aligned with two of the delimiting elements of the holding device due to a force of gravity; and
during transportation along the guide device the holding device together with the article is initially transported along a first rotary section and then along a second rotary section, a first rotational movement around a first axis of rotation is executed during transportation along the first rotary section and a second rotational movement around a second axis of rotation is executed during transportation along the second rotary section, wherein the first axis of rotation does not run parallel to the second axis of rotation, the first axis of rotation standing perpendicularly with respect to a transportation direction in the first rotary section and the second axis of rotation stands perpendicularly with respect to the transportation direction in the second rotary section.

8. The method according to claim 7, wherein during transportation along the first rotary section each of the holding devices is rotated such that a clearance occurs between the first axis of rotation and the holding device.

9. The method according to claim 7, which further comprises during transportation along the second rotary section each of the holding devices is rotated such that the second axis of rotation is moved as well during transportation.
